(19) United States
(12) Patent Application Publication
(10) Pub. No.: US 2009/0033594 A1
(43) Pub. Date: Feb. 5, 2009

(54) PLASMA DISPLAY AND DRIVING METHOD THEREOF

(76) Inventor: Jung-Soo An, Suwon-si (KR)

Correspondence Address: CHRISTIE, PARKER & HALE, LLP, PO BOX 7068, PASADENA, CA, 91109-7068, US

(21) Appl. No.: 12/179,151

(22) Filed: Jul. 24, 2008

(30) Foreign Application Priority Data
Aug. 3, 2007 (KR) 10-2007-0078197

(51) Int. Cl. G09G 3/28

(52) U.S. Cl. 345/60

(57) ABSTRACT

A plasma display device including first electrodes and second electrodes extending in one direction is disclosed. A first reset waveform is applied to the first electrodes and the second electrodes during a reset period of a first subfield, and a second reset waveform is applied to the first electrodes and the second electrodes during a reset period of a second subfield. A voltage at the second electrodes is gradually decreased from a second voltage to a third voltage while a first voltage is applied to the first electrodes during a preset period just before the reset period of the second subfield.

### CROSS-REFERENCE TO RELATED APPLICATION

This application claims priority to and the benefit of Korean Patent Application No. 10-2007-0078197, filed in the Korean Intellectual Property Office on Aug. 3, 2007, the entire content of which is incorporated herein by reference.

### BACKGROUND OF THE INVENTION

(a) Field of the Invention

The present invention relates to a plasma display device and a method of driving the same.

(b) Description of the Related Art

A plasma display device is a display device using a plasma display panel for displaying characters or image by using plasma generated by a gas discharge.

One frame of an image displayed on a plasma display panel is divided into a plurality of subfields having weight values. A discharge cell (hereinafter referred to as a “cell”) is initialized by a reset discharge during a reset period of each subfield, and light emitting cells and non-light emitting cells are selected by address discharges during an address period of each subfield.

The light emitting cells are sustain discharged during a sustain period of each subfield so that images are displayed. The reset period is either a main reset period or an auxiliary reset period. The reset discharge is generated in all the cells during the main reset period, and is only generated in a cell having undergone sustain discharge in the previous subfield during the auxiliary reset period.

However, wall charges formed at a light emitting cell can be erased by unstable address discharge and unstable sustain discharge. As a result, the light emitting cell can become a non-light emitting cell. When the light emitting cell becomes a non-light emitting cell, wall charges erased at the light emitting cell cannot be retrieved in the auxiliary reset period.

As a result, the plasma display device cannot represent correct grays levels.

The above information disclosed in this Background section is only for enhancement of understanding of the background of the invention, and therefore it may contain information that does not form the prior art that is already known in this country to a person of ordinary skill in the art.

### SUMMARY OF THE INVENTION

Embodiments of the present invention provide a plasma display device and a driving method thereof for forming sufficient wall charges in discharge cells before an auxiliary reset period.

An exemplary embodiment of the present invention provides a method of driving a plasma display device with one frame divided into a plurality of subfields. The plasma display device includes first electrodes, second electrodes and a plurality of discharge cells. According to the method, during a first reset period of a first subfield among the plurality of subfields, a voltage at a second electrode of the second electrodes is gradually increased from a second voltage to a third voltage while a first voltage is applied to a first electrode of the first electrodes. During the first reset period, the voltage at the second electrode is gradually decreased from a fifth voltage to a sixth voltage while a fourth voltage that is higher than the first voltage is applied to the first electrode. During a second reset period of a second subfield among the plurality of subfields, a voltage at the second electrode is gradually increased from an eighth voltage to a ninth voltage while a seventh voltage is applied to the first electrode. During a first period just before the second reset period, the voltage at the second electrode is gradually decreased from a fourteenth voltage to a fifteenth voltage while a thirteenth voltage is applied to the first electrode. A difference between the first voltage and the third voltage is greater than a difference between the seventh voltage and the ninth voltage, and a difference between the tenth voltage and the twelfth voltage is less than a difference between the thirteenth voltage and the fifteenth voltage.

Another exemplary embodiment of the present invention provides a method for driving a plasma display device with one frame divided into a plurality of subfields. The plasma display device includes first electrodes, second electrodes, third electrodes crossing the first electrodes and the second electrodes, and a plurality of discharge cells formed by the first electrodes, the second electrodes, and the third electrodes. According to the method, during a reset period of a first subfield of the plurality of subfields, a voltage difference between one of the first electrodes and a corresponding one of the second electrodes is gradually increased from a first voltage to a second voltage, and the voltage difference is gradually decreased from a third voltage to a fourth voltage. During a reset period of a second subfield of the plurality of subfields, the voltage difference is gradually increased from a fifth voltage to a sixth voltage that is lower than the second voltage, and the voltage difference is gradually decreased from a seventh voltage to an eighth voltage. During a preset period of the reset period of the second subfield, the voltage difference is gradually decreased from a ninth voltage to a tenth voltage that is lower than the eighth voltage.

Still another exemplary embodiment of the present invention provides a plasma display device including a plurality of first electrodes, a plurality of second electrodes for performing a display operation together with the plurality of first electrodes, a plurality of discharge cells, a controller for dividing a frame into a plurality of subfields, and a driver. The driver is configured to apply a first reset waveform to the plurality of discharge cells during a reset period of a first subfield among the plurality of subfields and apply a second waveform to the plurality of discharge cells during a reset period of a second subfield among the plurality of subfields, and is configured to gradually decrease the voltage at the plurality of second electrodes from a second voltage to a third voltage while a first voltage is applied to the plurality of first electrodes during a preset period of the reset period of the second subfield.

### BRIEF DESCRIPTION OF THE DRAWINGS

FIG. 1 is a block diagram of a plasma display device according to an exemplary embodiment of the present invention.

FIG. 2 illustrates a driving method of the plasma display device according to an exemplary embodiment of the present invention.

FIG. 3 is a drawing illustrating driving waveforms of the plasma display device according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, when an item is described to include constituent elements, it may further include other constituent elements unless it is expressly described that it does not include other constituent elements.

Wall charges refer to charges formed on walls of discharge cells neighboring electrodes and accumulated to the electrodes. Although the wall charges do not physically reside on the electrodes, it will be described that the wall charges are “generated,” “formed,” or “accumulated” thereon. Also, a wall voltage represents a potential difference formed on the walls of the discharge cells by the wall charges. A weak discharge is a discharge that is weaker than a sustain discharge in a sustain period and an address discharge in an address period.

The plasma display device and a driving method thereof according to an exemplary embodiment of the present invention will now be described in detail.

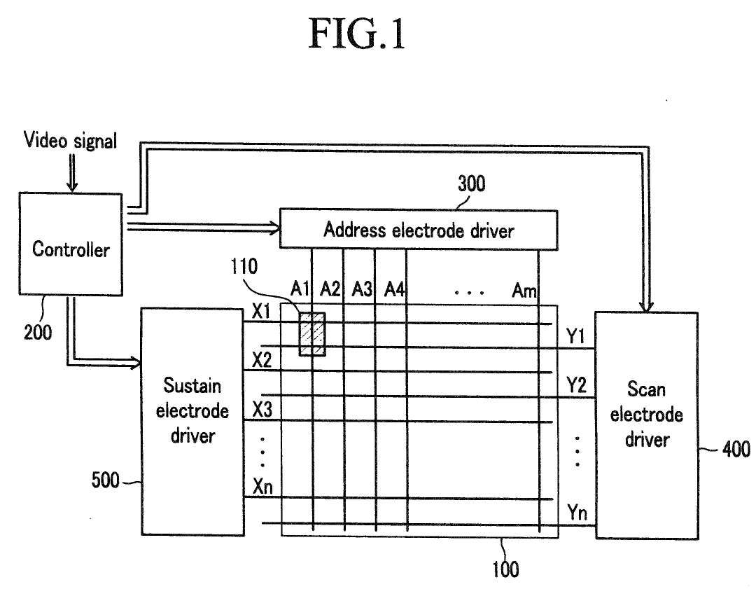

FIG. 1 is a schematic drawing illustrating a plasma display device according to an exemplary embodiment of the present invention.

As shown in FIG. 1, the plasma display device according to the exemplary embodiment of the present invention includes a plasma display panel (PDP) 100, a controller 200, an address electrode driver 300, a scan electrode driver 400, and a sustain electrode driver 500.

The PDP 100 includes a plurality of address electrodes A1-Am (referred to as “A electrodes” hereinafter) extending in a column direction, and a plurality of sustain electrodes X1-Xn (referred to as “X electrodes” hereinafter) and a plurality of scan electrodes Y1-Yn (referred to as “Y electrodes” hereinafter) extending in a row direction, forming pairs of X and Y electrodes.

In general, the X electrodes X1-Xn are formed to correspond to the respective Y electrodes Y1-Yn, and the X electrodes X1-Xn and the Y electrodes Y1-Yn perform a display operation during a sustain period in order to display an image.

The Y electrodes Y1-Yn and the X electrodes X1-Xn cross the A electrodes A1-Am.

Discharge spaces at crossing regions between the A electrodes A1-Am and the X and Y electrodes X1-Xn and Y1-Yn form cells 110. The structure of the PDP 100 is only one example, and a panel with a different structure to which driving waveforms described hereinbelow may also be applicable in the present invention.

The controller 200 receives a video signal from the outside of the plasma display device and outputs an A electrode driving control signal, an X electrode driving control signal, and a Y electrode driving control signal. The controller 200 drives a single frame by dividing it into a plurality of subfields.

The address electrode driver 300 receives the A electrode driving control signal from the controller 200 and applies a driving voltage to the A electrodes.

The scan electrode driver 400 receives the Y electrode driving control signal from the controller 200 and applies a driving voltage to the Y electrodes.

The sustain electrode driver 500 receives the X electrode driving control signal from the controller 200 and applies a driving voltage to the X electrodes.

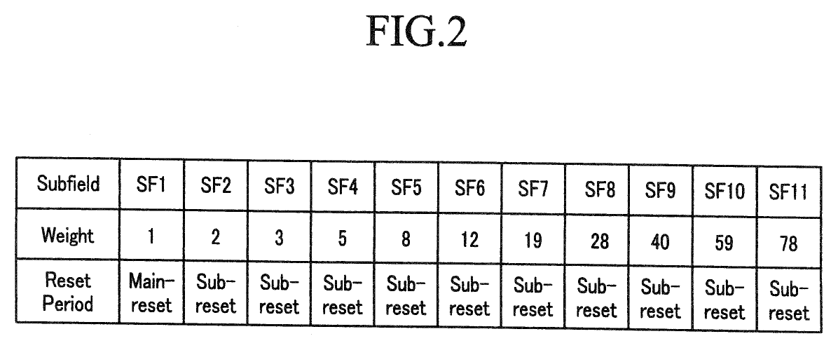

FIG. 2 illustrates a driving method of the plasma display device according to an exemplary embodiment of the present invention.

As shown in FIG. 2, one frame includes a plurality of subfields having respective weight values. In FIG. 2, one frame includes 11 subfields SF1-SF11 respectively having weights of 1, 2, 3, 5, 8, 12, 19, 28, 40, 59, and 78. Each subfield SF1-SF11 includes a reset period, an address period, and a sustain period. The reset period of one subfield among the plurality of subfields may be formed of a main reset period, and the reset periods of the other subfields may be formed of auxiliary reset periods. In FIG. 2, the reset period of the subfield SF1 is depicted as a main reset period, and the reset periods of the subfields SF2-SF11 are depicted as auxiliary reset periods.

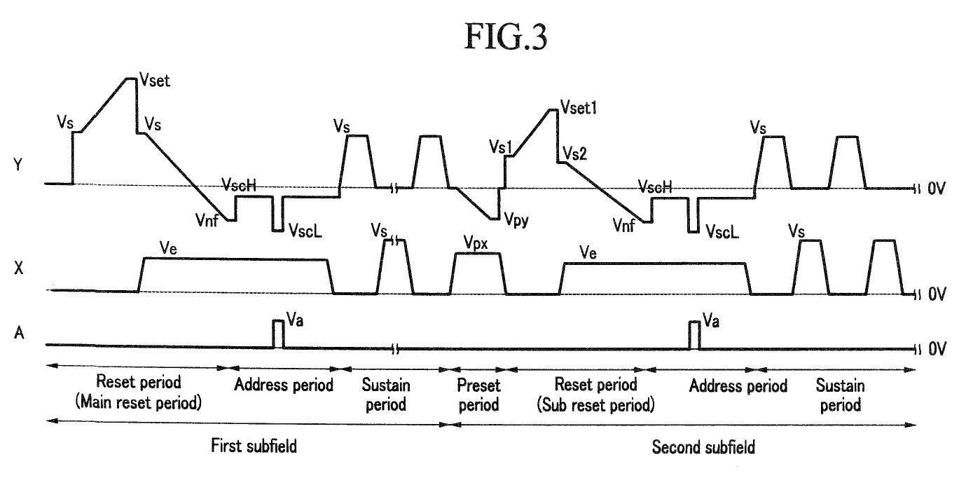

FIG. 3 is a drawing illustrating driving waveforms of a plasma display device according to an exemplary embodiment of the present invention. FIG. 3 shows a first subfield and a second subfield such as subfields SF1 and SF2 among the plurality of subfields that constitute one frame. FIG. 3. illustrates the driving waveforms applied to the X, Y, and A electrodes that correspond to a single discharge cell for better understanding and ease of description.

As shown in FIG. 3, in the main reset period of the first subfield (e.g., SF1), the address electrode driver 300 and the sustain electrode driver 500 bias the A and X electrodes to a reference voltage (e.g., 0V in FIG. 3), respectively, and the scan electrode driver 400 gradually increases the voltage of the Y electrodes from a voltage Vs to a voltage Vset.

In FIG. 3, the voltage of the Y electrodes is shown to increase in a ramp pattern.

Then, while the voltage of the Y electrodes is increasing, a weak discharge occurs between the Y and X electrodes and between the Y and A electrodes, forming negative (−) wall charges on the Y electrodes and positive (+) wall charges on the X and A electrodes.

The voltage of Vset may be set to be higher than a discharge firing voltage between the Y electrodes and the X electrodes to generate the weak discharge in all the cells.

Subsequently, the sustain electrode driver 500 biases the X electrodes to a voltage Ve and the scan electrode driver 400 gradually decreases the voltage of the Y electrodes from the voltage Vs to a voltage Vnf. In FIG. 3, the voltage of the Y electrodes is shown to decrease in a ramp pattern.

Then, while the voltage of the Y electrodes is decreasing, a weak discharge occurs between the Y and X electrodes and between the Y and A electrodes, erasing the negative (−) wall charges formed on the Y electrodes and the positive (+) wall charges formed on the X and A electrodes. The voltage of Ve and the voltage of Vnf may be set so that the wall voltage between the Y electrodes and the X electrodes is near 0V in order to prevent a misfiring discharge in a non-light emitting cell. That is, a voltage of (Ve-Vnf) is set to be close to the discharge firing voltage between the Y electrodes and the X electrodes.

In an address period, in order to select a light emitting cell, the sustain electrode driver 500 maintains the voltage of the X electrodes at the Ve voltage, and the scan electrode driver 400 and the address electrode driver 300 apply a scan pulse having the VscL voltage and an address pulse having the Va voltage to the Y electrodes and the A electrodes, respectively. Further, the scan electrode driver 400 biases an unselected Y electrode with a VscH voltage that is higher than a VscL voltage, and the address electrode driver 300 biases an A electrode of a non-light emitting cell with a ground voltage (e.g., 0V). The voltage VscL is set to a level that is equal to or lower than the voltage Vnf.

In detail, in the address period, the scan electrode driver 400 and the address electrode driver 300 apply a scan pulse to the Y electrode (e.g., Y1 in FIG. 1) of a first row and at the same time apply address pulses to the A electrodes positioned at light emitting cells in the first row. Then, address discharges occur between the Y electrode of the first row and the A electrodes to which the address pulses have been applied, forming positive (+) wall charges on the Y electrode and negative (−) wall charges on the A and X electrodes.

Subsequently, while the scan electrode driver 400 applies a scan pulse to the Y electrode (e.g., Y2 in FIG. 1) of a second row, the address electrode driver 300 apply address pulses to the A electrodes positioned at light emitting cells of the second row. Then, address discharges occur at cells corresponding to the A electrodes to which the address pulses have been applied and the Y electrode of the second row, forming wall charges in the cells.

Likewise, while sequentially applying scan pulses to the Y electrodes of the remaining rows by the scan electrode driver 400, the address electrode driver 300 applies address pulses to the A electrodes positioned at light emitting cells to form wall charges in the light emitting cells.

In the sustain period, the scan electrode driver 400 applies a sustain pulse having a high level voltage (e.g., Vs in FIG. 3) and a low level voltage (e.g., 0V in FIG. 3) to the Y electrodes a number of times corresponding to a weight value of the corresponding subfield. In addition, the sustain electrode driver 500 applies a sustain pulse to the X electrodes in a phase opposite to that of the sustain pulse applied to the Y electrodes.

Here, the voltage difference between the Y electrodes and the X electrodes is alternately a voltage of Vs and a voltage of −Vs. Therefore, in the light emitting cells, sustain discharge is repeatedly generated for the number of times (e.g., a predetermined number of times) the sustain pulses are applied.

According to an embodiment of the present invention, a preset period is included just before the auxiliary reset period of the second subfield (e.g., subfield SF2).

In the preset period, the sustain electrode driver 500 applies a voltage Vpx to the X electrodes and the scan electrode driver 400 gradually decreases the voltage of the Y electrodes from the reference voltage to a voltage Vpy.

Also, the address electrode driver 300 applies the reference voltage to the A electrodes. In the preset period, a difference between a voltage at the X electrodes and a voltage at the Y electrodes may be set to satisfy Equation 1 as follows:

|Ve−Vnf|<|Vpx−Vpy|<|Vp| (Equation 1)

Here, Vp may be determined by experimentation. Vp is a voltage level at which an amount of wall charges formed in the non-light emitting cells may reduce the weak discharge generated in the non-light emitting cells and may compensate for the wall charges erased in the light emitting cells.

That is, since the voltage of Ve and the voltage of Vnf may be set so that the wall voltage between the Y electrodes and the X electrodes is near 0V, when the absolute value of a voltage of (Vpx-Vpy) is greater than the absolute value of a voltage of (Ve-Vnf) and is smaller than Vp, positive (+) wall charges and negative (−) wall charges may be properly formed at the Y electrodes and the X electrodes of all the cells, respectively.

Thus, although wall charges formed in the light emitting cells are erased by an unstable address discharge and an unstable sustain discharge, driving waveforms according to an exemplary embodiment of the present invention may compensate wall charges erased in the light emitting cell during the auxiliary reset period.

In the auxiliary reset period of the second subfield (e.g., subfield SF2), the sustain electrode driver 500 applies the reference voltage to the X electrodes and the scan electrode driver 400 gradually increases the voltage of the Y electrodes from a voltage Vs1 to a voltage Vset1.

While the voltage at the Y electrode increases, a weak discharge is generated between the Y electrode and the X electrode of the light emitting cell when a sum of the voltage applied to the Y electrode and a wall voltage between the Y electrode and the X electrode of the light emitting cell exceeds the discharge firing voltage. Additionally, a weak discharge is generated between the Y electrode and the A electrode of the light emitting cell when a sum of the voltage applied to the Y electrode and a wall voltage between the Y electrode and the A electrode of the light emitting cell exceeds the discharge firing voltage.

As a result, negative (−) wall charges are formed on the Y electrode of the light emitting cell and positive (+) wall charges are formed on the X electrode and the A electrode of the light emitting cell. In addition, since positive (+) wall charges and negative (−) wall charges are respectively formed on the Y electrode and X electrode of the non-light emitting cell, a weak discharge may be generated between the Y electrode and the X electrode of the non-light emitting cell and the Y electrode and A electrode of the non-light emitting cell. However, in the auxiliary reset period, since the weak discharge generated in the non-light emitting cell is weaker than the weak discharge generated in the light emitting cell, the weak discharge in the non-light emitting cell does not have a significant effect on background luminance.

The reset period of the second subfield (e.g., subfield SF2) is an auxiliary reset period. Therefore, the reset discharge is generated when the sustain discharge is generated in a previous subfield. That is, the voltage of Vset1 may be set to a voltage so that a reset discharge is not generated when a sustain discharge is not generated in the previous subfield.

Accordingly, the voltage of Vset1 may be set to be lower than the voltage of Vset because a discharge may be generated in all the cells when the voltage at the Y electrodes increases to the voltage of Vset as described above. Furthermore, in the auxiliary reset period, a difference between a voltage at the Y electrodes and a voltage at the X electrodes may be set to voltage that satisfies Equation 2 as follows:

|Vset1−0V|<|Ve−Vnf| (Equation 2)

That is, since a small quantity of wall charges are formed in the non-light emitting cells, when the voltage of Vset1 is less than the absolute value of a difference between the voltage of Ve and the voltage of Vnf, the weak discharge may be generated in the non-light emitting cells during the auxiliary reset period.

As described above, according to an exemplary embodiment of the present invention, wall charges erased in the light emitting cells during the preset period just before the reset period are compensated such that the weak discharge in the light emitting cells may be generated stably. In addition, a small quantity of wall charges are formed in the non-light emitting cells during the preset period such that the strength of the weak discharges generated in the non-light emitting cells may be reduced.

Subsequently, during the auxiliary reset period, the sustain electrode driver 500 and the address electrode driver 300 apply the voltage Ve and the reference voltage to the X electrodes and the A electrodes, and the scan electrode driver 400 gradually decreases the voltage of the Y electrodes from a voltage Vs2 to the voltage Vnf. Because gradually decreasing the voltage at the Y electrodes from the voltage of Vset1 to the voltage of Vnf would increase the length of the reset period, the voltage at the Y electrodes is decreased from the voltage of Vs2 that is a level that does not cause the discharge. While the voltage of the Y electrodes is decreasing, a weak discharge is generated between the Y and the X electrodes of the light emitting cells and between the Y and A electrodes of the light emitting cells. Thus, the negative (−) wall charges formed on the Y electrodes are erased, and the positive (+) wall charges formed on the X and A electrodes are erased. In addition, while the voltage of the Y electrodes is decreasing, a weak discharge is generated between the Y and X electrodes of the light emitting cells and between the Y and A electrodes of the non-light emitting cells. Thus, the negative (−) wall charges formed on the Y electrodes of the non-light emitting cells are erased, and the positive (+) wall charges formed on the X and A electrodes of the non-light emitting cells are erased. Likewise, while the voltage of the Y electrodes is decreasing, the weak discharge generated in the non-light emitting cells is weaker than the weak discharge generated in the light emitting cells.

Next, in the second subfield (e.g., subfield SF2), the light emitting cells and the non-light emitting cells are selected by the address discharge in the address period, and the sustain discharge operation is performed for the light emitting cells in the sustain period.

As described above, according to an exemplary embodiment of the present invention, although wall charges formed in the light emitting cells are erased by unstable address discharge and unstable sustain discharge, a weak discharge is steadily generated in the light emitting cells, because erasing wall charges in the light emitting cells are compensated in the auxiliary reset period.

Thus, a plasma display device according to an exemplary embodiment of the present invention can display a correct grayscale.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims and their equivalents.

What is claimed is:

1. A method for driving a plasma display device with one frame divided into a plurality of subfields, the plasma display device comprising first electrodes, second electrodes, and a plurality of discharge cells, the method comprising:
gradually increasing a voltage at a second electrode of the second electrodes from a second voltage to a third voltage while a first voltage is applied to a first electrode of the first electrodes during a first reset period of a first subfield among the plurality of subfields;
gradually decreasing the voltage at the second electrode from a fifth voltage to a sixth voltage while a fourth voltage that is higher than the first voltage is applied to the first electrode during the first reset period;
gradually increasing the voltage at the second electrode from an eighth voltage to a ninth voltage while a seventh voltage is applied to the first electrode during a second reset period of a second subfield among the plurality of subfields;
gradually decreasing the voltage at the second electrode from an eleventh voltage to a twelfth voltage while a tenth voltage is applied to the first electrode during the second reset period; and
gradually decreasing the voltage at the second electrode from a fourteenth voltage to a fifteenth voltage while a thirteenth voltage is applied to the first electrode during a first period just before the second reset period,
wherein a difference between the first voltage and the third voltage is greater than a difference between the seventh voltage and the ninth voltage, and a difference between the tenth voltage and the twelfth voltage is less than a difference between the thirteenth voltage and the fifteenth voltage.

2. The method of claim 1, wherein the difference between the seventh voltage and the ninth voltage is smaller than the difference between the tenth voltage and the twelfth voltage.

3. The method of claim 2, wherein the first voltage is equal to the seventh voltage, the fourth voltage is equal to the tenth voltage, and the sixth voltage is equal to the twelfth voltage.

4. The method of claim 2, further comprising:
in each of the first subfield and the second subfield, selecting a light emitting cell and a non-light emitting cell among the plurality of discharge cells during an address period; and
sustain discharging the light emitting cell during a sustain period.

5. A method for driving a plasma display device with one frame divided into a plurality of subfields, the plasma display device comprising first electrodes, second electrodes, third electrodes crossing the first electrodes and the second electrodes, and a plurality of discharge cells formed by the first electrodes, the second electrodes, and the third electrodes, the method comprising:
gradually increasing a voltage difference between one of the first electrodes and a corresponding one of the second electrodes from a first voltage to a second voltage, and gradually decreasing the voltage difference from a third voltage to a fourth voltage during a reset period of a first subfield of the plurality of subfields;
gradually increasing the voltage difference from a fifth voltage to a sixth voltage, which is lower than the second voltage, and gradually decreasing the voltage difference from a seventh voltage to an eighth voltage during a reset period of a second subfield of the plurality of subfields;
gradually decreasing the voltage difference from a ninth voltage to a tenth voltage, which is lower than the eighth voltage, during a preset period of the reset period of the second subfield.

6. The method of claim 5, wherein the fourth voltage is equal to the eighth voltage.

7. A plasma display device comprising:
a plurality of first electrodes;
a plurality of second electrodes for performing a display operation together the plurality of first electrodes;
a plurality of discharge cells;
a controller for dividing a frame into a plurality of subfields; and
a driver for applying a first reset waveform to the plurality of discharge cells during a reset period of a first subfield among the plurality of subfields, for applying a second waveform to the plurality of discharge cells during a reset period of a second subfield among the plurality of subfields, and for gradually decreasing the voltage at the plurality of second electrodes from a second voltage to a third voltage while a first voltage is applied to the plurality of first electrodes during a preset period of the reset period of the second subfield.

8. The plasma display of claim 7, wherein the second reset waveform is a waveform for gradually increasing the voltage at the plurality of second electrodes from a fifth voltage to a sixth voltage while a fourth voltage is applied to the plurality of first electrodes, and for gradually decreasing the voltage at the plurality of second electrodes from an eighth voltage to a ninth voltage while a seventh voltage is applied to the plurality of first electrodes, and
wherein a difference between the seventh voltage and the ninth voltage is smaller than a difference between the first voltage and the third voltage.

9. The plasma display of claim 8, wherein the first reset waveform is a waveform for gradually increasing the voltage at the plurality of second electrodes from an eleventh voltage to a twelfth voltage while a tenth voltage is applied to the plurality of first electrodes, and for gradually decreasing the voltage at the plurality of second electrodes from a fourteenth voltage to a fifteenth voltage while a thirteenth voltage that is higher than the tenth voltage is applied to the plurality of first electrodes, and
wherein a difference between the tenth voltage and the twelfth voltage is greater than a difference between the fourth voltage and the sixth voltage.

10. The plasma display of claim 9, wherein a difference between the sixth voltage and the fourth voltage is smaller than a difference between the seventh voltage and the ninth voltage, and a difference between the twelfth voltage and the tenth voltage is greater than a difference between the thirteenth voltage and the fifteenth voltage.

11. The plasma display of claim 10, wherein the fourth voltage is equal to the tenth voltage, the seventh voltage is equal to the thirteenth voltage, and the ninth voltage is equal to the fifteenth voltage.
